(19) United States
(12) Patent Application Publication
(10) Pub. No.: US 2025/0166535 A1
(43) Pub. Date: May 22, 2025

(54) VIDEO INFORMATION DISPLAY SYSTEM FOR A MOVING OBJECT

(71) Applicants: Olga Lvovna BAGAEVA, Krasnoyarsk (RU); Maksim Sergeevich BAGAEV, Krasnoyarsk (RU)

(72) Inventors: Olga Lvovna BAGAEVA, Krasnoyarsk (RU); Maksim Sergeevich BAGAEV, Krasnoyarsk (RU)

(21) Appl. No.: 19/004,608

(22) Filed: Dec. 30, 2024

Related U.S. Application Data
(63) Continuation-in-part of application No. 17/600,448, filed on Sep. 30, 2021, now abandoned.

(51) Int. Cl. G09F 19/22; G09F 9/33; G09F 19/14

(52) U.S. Cl. CPC G09F 19/226; G09F 9/33; G09F 19/14; G09F 2019/221

(57) ABSTRACT

The invention relates to a system for displaying dynamic and static images for advertising or informational purposes in moving vehicles, such as trains or metro. The system includes linear emitter modules installed along the windows, which synchronize video content with the movement of the vehicle and display it to passengers. These modules do not contain moving parts, ensuring high reliability and low maintenance. They use passive optical networks (PON) for synchronization and data transmission, and support dynamic content such as Full HD or 4K video. Additionally, the system provides interactive engagement through a mobile app, allowing passengers to participate in games or receive personalized content. The system ensures precise synchronization with each metro or train car, compensating for changes in speed and acceleration, providing uninterrupted viewing.

### CROSS-REFERENCES

This patent application is a Continuation-in-Part of U.S. patent application Ser. No. 17/600,448 filed Sep. 30, 2021, which is National stage application from the PCT application PCT/RU2020/050031 filed Feb. 28, 2020.

### SUMMARY OF THE INVENTION

The technical objective of this invention is to develop a system for displaying visual information at the window level to viewers/passengers in a moving vehicle, assuming that the viewer/passenger is moving relative to any stationary information display systems. Due to the movement of the viewer/passenger relative to these systems, the image is mechanically unfolded, and the picture becomes coherent for the viewer/passenger.

The technical result of applying the invention is that the proposed system does not contain mechanical moving parts, is highly reliable, and resistant to external influences (such as moisture, etc.). The linear emitter modules do not have moving components and do not require regular maintenance. These modules consist of a control unit and a display unit. The emitter module may contain only the control unit or only the display unit to reduce the overall system cost.

One emitter module, containing the control unit, can manage multiple emitter modules that contain only the display unit. The synchronization is contactless, as no physical contact with the train is required, resulting in more precise synchronization. Each train car is synchronized with the emitter modules individually. The synchronization module with the train transmits information about the location of each train car to external systems in real-time. There is the ability to quickly and remotely change the displayed information, with information updates occurring very rapidly. Additionally, dynamic images can be displayed. Light-emitting elements, such as LEDs, semiconductor lasers, or other light-generating means, can be used. The microcontroller/microprocessor in the control unit performs automatic calibration of the light-emitting elements, significantly reducing the cost. High-precision clocks ensure parallel synchronization of all emitter modules for stable system operation via the optical network. A network optical interface, PON (Passive Optical Network), is used. The video information display system provides interactive communication with the viewer/passenger in the vehicle through a mobile application on the passenger's phone, which connects to the server controlling the video display system in the tunnel.

### BACKGROUND OF THE INVENTION

A method for presenting visual information to viewers on a moving vehicle is known (Patent No. 2053574, IPC G09F21/04). This method involves arranging information carriers in a systematic sequence along the vehicle's route. The duration of illumination for each information carrier and the display time for each viewer are selected to be shorter than the time it takes for the vehicle to pass along the route.

The drawback of this method is the pulsed impact on the retina and the difficulty of adjusting the playback system according to the passenger's speed.

Animation in metro tunnels is known (Patent FR2539903, IPC G09F19/22, dated 1984 Jul. 27). This involves using general-interest or advertising information characterized by images (4) attached to the walls of the metro tunnel. These images are illuminated by light spots (3) mounted on the outside of the train and triggered for short moments by photovoltaic cells (2) connected to the light spots (3).

According to claim 1, animation is achieved by placing images (4) and mirrors (1) on the walls of the metro tunnel. According to claim 2, the animation operates with a metro speed of approximately 60 km/h, with images placed every two meters and illuminated by photoelements.

The disadvantage of this known technical solution is the limited amount of information conveyed due to the short viewing time for each image, as part of the viewing time is spent on the eyes adapting to the light spot. Additionally, there is no capability to quickly change the image, nor is there any ability to display dynamic images.

A system for displaying images on a transportation route is known (Patent RF 71465, IPC G09F19/12, issued on 10 Mar. 2008). The system includes a transportation route, a vehicle with at least one window moving along a fixed path at an essentially constant speed VV, and an information carrier consisting of multiple sequentially installed informational elements. These elements contain frames with images that depict consecutive phases of an object's motion. The system also includes supports that secure the information carrier along one side of the fixed path and a lighting system.

The system is characterized by the fact that each image has an actual width and a center, with the centers of the sequential informational elements in the same row separated by an interframe distance. The system includes an initiation point located at a distance HH from the first frame.

Each informational element can rotate around an axis passing through the image's center and has two extreme positions, defined by the angle αα between the frontal plane of the informational element displaying the frame and the vehicle's trajectory: α=10-55° α=10-55° for the first extreme position and α=0° α=0° for the second. The angular rotation speed of the informational element as it moves from the first extreme position to the second is calculated based on the window's width and the vehicle's average speed along the segment of the transportation route where the information is displayed.

The system in claim 1, characterized by the vehicle being equipped with a lighting system that illuminates the informational elements, synchronized with the sequence of images and the vehicle's speed.

The system in claim 1, characterized by the information carrier being equipped with a lighting system that illuminates the informational elements, synchronized with the sequence of images and the vehicle's speed.

The drawback of this known technical solution is its complexity of implementation, the presence of moving parts, significant maintenance costs, and the dependency of image quality on the viewer's movement speed. Additionally, it lacks the capability to quickly replace images and fundamentally cannot display dynamic images.

A known advertising system for metro tunnels includes a display panel attached to the walls or ceiling of the tunnel, with a drum onto which a film is wound. Passengers can see a moving image through the window (Patent GB No 2272557, IPC G09F19/22).

The drawback of this known technical solution is the use of information transmission over a limited section of the route, the complexity of maintenance, the inability to quickly change images, and the fundamental lack of capability to display dynamic images.

A known device for displaying individual images consists of separate images mounted along the route of a metro train or urban railway at the level of the windows, allowing the viewer to perceive them as a moving image (Patent DE435148, IPC G09F19/22).

The drawback of this development is the pulsed method of impacting the retina, the complexity of maintenance, the inability to quickly change images, and the fundamental lack of capability to display dynamic images.

The closest prior art to the proposed invention is A system for displaying images to passengers in a vehicle travelling along a path, e.g. in a railway tunnel, comprises a sensor arrangement, a plurality of display apparatuses arranged along the path and a control arrangement. Each display apparatus is controlled to generate an apparently stationary video by persistence of vision. Each display apparatus is further adapted to detect faults related to the output of the images, to store parameters indicative of the detected faults, and to transmit the parameters to a remote device for consolidation of the parameters. The system may further comprise an Ethernet network wherein the display apparatuses each include an Ethernet switch to connect to the network and a power supply to power the Ethernet switch, the switch being adapted to draw power over Ethernet (PoE) if the power supply fails. (Patent GB 2525016 A).

The drawbacks of this solution include:

1.1. The need to create Ethernet network rings to enhance reliability, which, in turn, necessitates collision filtering—specifically, duplicate packets. This significantly reduces data transmission speed, as each ring decreases bandwidth by at least 50% (since duplicate packets occupy time slots). For example, for a typical segment 1 km in length, at least 100 rings would be required, reducing network bandwidth by at least 100 times. This severely limits the ability to update video information in real-time.

1.2. The requirement to install Ethernet switches in each module significantly increases the cost of the modules, reducing the project's investment appeal. Attempts to compensate for the issue described in 1.1 by using higher-speed protocols (e.g., 1 Gbps or 2.5 Gbps) would further escalate the cost of switches within the modules.

1.3. The Ethernet protocol is not a synchronous data transmission protocol, and the high-level NTP protocol, commonly used for clock synchronization in computers, has a maximum accuracy of 1 millisecond. However, for the synchronous operation of emitter modules, synchronization accuracy of no more than 1 nanosecond is required. Poor synchronization results in image jitter, as modules may display different parts of a frame or entirely different frames.

1.4. The sequential connection significantly reduces the overall reliability of the system, and any damage to even a single connection will cause problems, despite the use of Ethernet network rings. Additionally, this will alter the synchronization path, which, as noted in point 1.3, further degrades the image quality.

1.5. The identification of modules is carried out using the MAC addresses of Ethernet adapters, which significantly complicates the software identification of the modules and their management from a central computer.

1.6. The use of traditional Ethernet with a physical copper line parallel to the contact rail for powering the train, creates ideal conditions for receiving wideband interference, both from the power line itself and from the train's current collectors and engines. As a result, a large number of damaged packets will occur, leading to a significant decrease in data transmission speed. The most interference will be captured by ring networks, as they will have considerable length, making them susceptible to powerful disturbances that can pass through Ethernet isolation transformers and disrupt the operation of the emitter modules. Attempting to protect the cable network from interference will increase the cost of the solution and reduce the investment attractiveness of the project.

Significant Differences of the Invention from Known Technical Solutions:

### From Patent 2053574:

Depending on the speed of the viewer's movement, the system can adjust the speed and method of displaying information, ensuring a high-quality image across the entire range of permissible speeds.

### From Patent 71465:

1. The use of this invention enhances the effect of advertising by stimulating passenger's interest and also calming passengers who are prone to claustrophobia (in sufficiently long tunnels or shafts).

2. The distinction of the proposed invention is that the linear modules generate any image themselves. There is no pre-existing image fixed to the informational elements.

3. The interval between the linear modules of the proposed image is, for example, 1 meter.

4. Synchronization with the moving object is possible but not mandatory.

5. There is no rotation in the proposed linear modules, as the image is projected perpendicular to the viewer's movement.

6. Neither the vehicle nor the linear modules are externally illuminated and do not contain additional lighting systems.

7. The viewer/passenger in the car can fully perceive the information from the start of the trip through the tunnel, thanks to our invention.

8. Our modules do not contain moving parts and do not require regular maintenance.

9. There is the possibility of quickly and remotely changing the displayed information. Information changes can occur very rapidly.

10. No adaptation or additional actions are required from the passenger for visual perception of the information.

### From Patent DE No435148:

1. The proposed invention uses linear modules that project the image.

2. The invention does not use a pulsed method of impact, and the system is remotely controllable, allowing for quick reloading of any information, as well as the ability to display dynamic images.

### From Patent 2272557:

1. The invention uses linear modules that project an image, which maximally creates the illusion of the passenger being in another place.

2. The modules can be placed along the entire path, in any metro tunnels or other locations.

3. The invention does not use a pulsed method of impact, and the system is remotely controllable, allowing for quick reloading of any information, as well as the ability to display dynamic images.

### From Patent GB 2525016 A:

1. Our invention is free from the above-mentioned drawbacks of Patent GB 2525016 A, as our invention uses the PON (Passive Optical Network) instead of the Ethernet protocol.

1.1. The parallel connection of modules eliminates the need to create rings to enhance reliability; as a result, there are no issues with data transmission speed or maintaining an interactive mode.

1.2. The parallel connection of modules does not require switches and has no problems with data transmission speed due to the broadcast transmission of information.

1.3. The synchronization accuracy of the emitter modules in our invention is no more than 1 nanosecond.

1.4. There are no reliability issues due to the parallel connection.

1.5. Physical numerical identification of the emitter modules is used, which eliminates problems with further software identification from the server-side software.

1.6. The use of an optical medium for transmitting information completely eliminates the entry of any interference into the modules through the information inputs;

2. In our invention, wagon-based synchronization is used:

2.1. Acceleration of the train will not negatively affect the image quality, as each train car will be individually synchronized with the emitter modules.

2.2. Damage to the marker or other synchronization disruptions with the emitter modules may slightly degrade the image quality, as the previous speed and acceleration from the previous train car will be used.

3. Our invention includes: Automatic calibration (clause 6 of the claim).

Automatic calibration is necessary for the stable operation of the emitter modules.

This ensures that all emitter modules have the same brightness, both within the module itself and across the entire tunnel.

During calibration, the current output by each LED control chip is measured, and the pulse duration (or control current) applied to each LED is adjusted. The current of each chip, which generates PWM modulation or an analog signal, is also measured. In both cases, automatic calibration adjusts the brightness of the LEDs, either by balancing the current or adjusting the pulse duration.

The calibration values are stored in each emitter module, which are then used for the subsequent operation of the modules. The mechanism is fully automatic and is performed by the microprocessor.

4. Our invention includes: Interactive interaction. According to paragraph 1, we have the ability to transmit information very quickly (using the PON network (Passive Optical Network)), and as the result, enable interactive interaction. The proposed system provides interactive communication with the viewer (passenger) in the vehicle through a mobile application on the viewer's/passenger's phone, which connects to a server that manages the information display system in the tunnel. For example, the connection is made via Wi-Fi or another available communication method that can provide data transmission through the internet.

The viewer/passenger, by downloading the necessary application to their smartphone, can control a character that will act outside the vehicle window. For example, with the phone equipped with an accelerometer and gyroscope, the passenger can control objects outside the train window by changing the phone's position (tilting, acceleration, rotating the phone) while the system is in operation (during a ride in the metro tunnel where the equipment is installed).

For instance, if the video displays the ocean, the passenger could control a fish. This fish can collect a bonus (such as a discount on a service/product, etc.) from the advertiser. This significantly enhances the effect of the advertisement and increases the viewer's/passenger's engagement in the action unfolding outside the vehicle.

5. Our invention includes: An emergency mode to assist in finding the exit from the tunnel. The connection of our modules is highly reliable, and the system as a whole can provide assistance to passengers.

6. Our invention includes: A mode for displaying operational information for train operators—the system can quickly display information for train control, thereby enhancing the safety of metro operations. This functionality will be especially valuable in large and complex metro systems—for example, it will be very useful in the New York City subway.

7. To reduce the cost, the system has been developed in which the linear emitter module contains both a control unit and a display unit, and it is connected to modules that only have display units. Additionally, the module may contain only the control unit, and it can be connected to modules containing only the display unit, which further reduces the overall cost of the system.

### FIELD OF THE INVENTION

This invention pertains to methods and devices for creating dynamic and static images for advertising or other purposes, such as showcasing attractions or presenting other types of information.

It is well known that the number of tunnels is increasing in highly developed countries and major cities. Therefore, the use of this invention enhances the effectiveness of advertisements by capturing passengers' attention and also helps to calm passengers who are prone to claustrophobia (especially in sufficiently long tunnels or shafts).

This invention assumes that the viewer/passenger moves relative to stationary information display systems. Due to the movement of the viewer/passenger relative to these systems, the image is mechanically unfolded, and the picture becomes coherent for the viewer/passenger.

The proposed invention has a wide range of applications, with the main areas of application being:
Advertising: Creating engaging content that influences passengers.
Education and entertainment: Multimedia shows or informational stories.
Tourism: Virtual tours enhanced with visual effects outside the windows.

The system can be installed in:
Metro tunnels: Any image or information can be projected, with the viewer/passenger observing the image from the train window—possibilities include creating an underwater world or any other design.
Railway transport: Stations, tunnels—similar applications as in the metro tunnel.
Roadways:
a) Embedding emitter modules into the road, which illuminate and project lines onto the road that can form an image (for example, a laser projector positioned above the road projects a line, and the viewer moving along the road sees the image extended along the road).
b) Roadways with embedded information display elements in the surface, barriers, advertising, or other structures, so that the moving driver and passengers see a coherent image.
c) Installation along roads, similar to the installation in metro tunnels.
d) Installation in tunnels.
e) Amusement attractions.
f) Elevator shafts, lifts.

### BRIEF DESCRIPTION OF DRAWINGS

Therefore, the following description should not be understood in a limited sense, and the scope of the invention is defined by the appended claims.

The essence of the proposed invention is explained with the drawings.

FIG. 1 schematically illustrates the video information display system for a moving object.

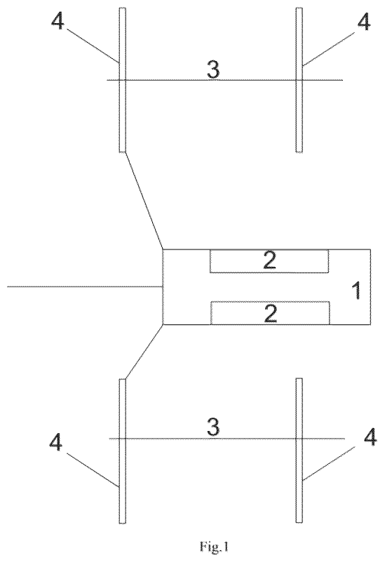

FIG. 2 shows the same, illustrating the linear emitter module device.

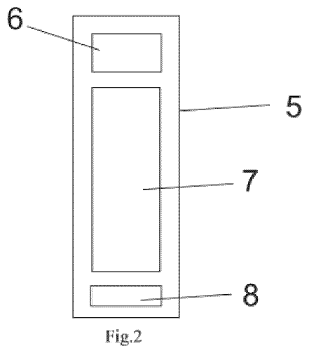

The positions are denoted as follows: 1—train car of the electric train; 2—window in the train car; 3—tunnel wall; 4—emitter modules; 5—housing; 6—control unit (which may contain an unshown microcontroller/microprocessor, network module, high-precision clock, memory, synchronization module with the train); 7—display unit (which contains unshown RGB LEDs, LED drivers, driver control logic, stream receiver, power converter); 8—power supply unit.

### DETAILED DESCRIPTION

The invention is a complex and innovative video information display system designed for passengers in moving vehicles. It aims to create an immersive effect and enable interactive engagement.

### Key Elements of the System:

1. Linear Emitter Modules:
   Installed at the height of vehicle windows, ensuring the perception of information as the moving image.
   They generate video synchronized with the vehicle's motion, creating a seamless playback effect.
2. Data Transmission Technology:
   Uses the Passive Optical Network (PON) to provide high-speed data transmission with minimal latency.
   This solution is optimal for synchronizing a large number of modules.
3. Control and Display Units:
   The control unit includes a microcontroller, vehicle synchronization, network module, and high-precision clocks.
   The display unit is equipped with RGB LEDs, drivers, and control logic to ensure high-quality video transmission (up to Full HD and 4K formats).
4. Synchronization:
   Infrared lasers, optical beams, and ultrasound are used for precise system operation.
   Personalized wagon-based synchronization is implemented for accuracy.
5. Interactive Capabilities:
   Passengers can interact with the system via a mobile application, enhancing engagement.
   This opens up opportunities for interactive advertising and entertaining content.

### Additional Features:

1. Configuration Flexibility:
   Modules with separate control and display units reduce costs.
   Data storage and processing with high resolution (8-bit or higher) improves image quality.
2. Wagon-Based Synchronization:
   Ensures precise video display in accordance with the position of each train car.
3. Calibration and Diagnostics:
   Automatic calibration of light-emitting elements reduces maintenance costs and improves system reliability.
4. Real-Time Interaction with External Systems:
   Real-time transmission of train car location data allows integration with other transportation systems.

### Potential Applications:

Advertising: Creates captivating content that influences passengers.
Education and Entertainment: Multimedia shows or informational narratives.
Tourism: Virtual tours enhanced with visual effects outside the windows.

### Possible Improvements:

1. Development of Interactive Features:
   Using Augmented Reality (AR) technology for passenger interaction with content.
   Expanding mobile app functionality, such as adding gamification elements.
2.Energy Efficiency:
   Using more energy-efficient LEDs and power management methods.
3. Scalability:
   Adapting the system for use in other types of transport (buses, airplanes) or stationary facilities.

This solution has the potential to become a milestone in transportation technology, combining multimedia experiences with digital innovation.

The system, being remotely controllable, allows for the rapid reloading of information, providing an unlimited volume of images and video content. It also enables the display of full-color video information. Additionally, it can display service or emergency information. The system can be used as an alert system in emergency situations (for example, indicating evacuation routes). The system can also, for instance, display information on the walls in front of the train operator, allowing them to see the image: turns, speed control, or other necessary information. This functionality will be especially valuable in large and complex metro systems—for example, it would be very useful in the New York subway.

The system can display service information, such as emergency or useful information on roads. The platform allows for wide application. For example, another application could be on highways. The system can be installed at a turn. If there is a small sign at the beginning, linear modules can be placed along the entire turn to display video or a static image, for example, showing the turn arrow at night or in low light (it will be more visible in the dark). This could significantly improve road safety. On highways, information could be projected onto the road surface.

### Example

The viewer/passenger is traveling in the lead car of the metro train. As the first linear emitter module passes by, it renders the first frame, displaying the fish or something else. Then the second linear emitter module passes, displaying the second frame, and so on. When the speed is sufficiently high, the emitter modules may repeat frames. In other words, the frame display speed changes depending on the speed of the viewer/passenger.

It is also possible for the viewer/passenger to interact interactively with the system that controls the display of information in the tunnel through a mobile application on the viewer's/passenger's phone.

For example, the connection is made via Wi-Fi or another available communication method that can provide data transmission through the internet.

The viewer/passenger, by downloading the necessary application to their smartphone, can control a character that will act outside the vehicle window. For example, with the phone equipped with an accelerometer and gyroscope, the passenger can control objects outside the train window by changing the phone's position (tilting, acceleration, rotating the phone) while the system is in operation (during a ride in the metro tunnel where the equipment is installed).

For instance, if the video displays the ocean, the passenger could control a fish. This fish can collect a bonus (such as a discount on a service/product, etc.) from the advertiser. This significantly enhances the effect of the advertisement and increases the viewer's/passenger's engagement in the action unfolding outside the vehicle.

### DETAILED DESCRIPTION OF THE INVENTION

In the following detailed description, reference is made to the accompanying drawings, which form part of it, and in which specific embodiments are shown that illustrate possible implementations of the invention. These embodiments are described in sufficient detail to allow professionals in the field to apply them in practice, and it should be understood that other embodiments may be used and that structural, logical, and electrical changes can be made without deviating from the scope of the invention. Such embodiments of the invention may be referred to individually and/or collectively in this document using the term “invention” simply for convenience and without any intention to voluntarily limit the scope of this application to any one specific invention or inventive concept if more than one is actually disclosed.

The description of the device is presented only as an example of one implementation of the present invention.

The system contains a plurality of linear emitter modules located perpendicular to the direction of movement of the viewer/passenger. These modules generate images from memory, synchronizing the speed and method of display with the viewer's/passenger's movement relative to the emitter modules. The emitter modules are mounted on both walls of the tunnel at evenly spaced intervals, for example, 1 meter apart. The height and positioning of the emitter modules ensure high-quality viewing from the windows of the metro train, creating the illusion of full immersion in another reality around the moving vehicle, typically from 1.5 meters and more. The number of elements illuminated in each linear module depends on the bandwidth and quality of the video to be displayed.

All emitter modules are interconnected via the network optical interface, PON (Passive Optical Network). The linear emitter modules contain the control unit and the display unit. Each linear emitter module has a housing 5 that contains the control unit 6, which includes:
the microcontroller/microprocessor that controls the operation of the module; the network module with an optical interface; the synchronization module with the train (with each car); high-precision clocks ensuring the synchronization of all emitter modules for stable operation of the system over the PON optical network, memory (not shown in the figure), connected to the microcontroller/microprocessor; the microcontroller/microprocessor also manages the process of extracting video frames from memory and transmitting them to the display unit 7; which include RGB LEDs, LED drivers, driver control logic, stream receiver, power converter (not shown in the figure); power supply unit 8.

There are variations of the emitter module that include either both the control and display units, or just the control unit, or just the display unit.

The emitter module, containing both the control unit and the display unit, can manage emitter modules that contain only display units, which significantly reduces the cost of the system.

The control unit may be placed in a separate module, which can manage emitter modules that only have display units, which also significantly reduces the cost of the system.

The microcontroller/microprocessor (not shown) manages the entire device.

The microcontroller/microprocessor also performs automatic calibration of the light-emitting elements in the display unit. Automatic calibration is necessary for the stable operation of the emitter modules.

This is done to ensure that all emitter modules have the same brightness, both within the module itself and across the entire tunnel. During calibration, the current supplied by each LED control chip is measured, and the pulse duration (or control current) applied to each LED is adjusted. The current of each chip, which generates the PWM (Pulse Width Modulation) or analog signal, is measured. In both cases, the automatic calibration adjusts the brightness of the LEDs by either balancing the current or the pulse duration.

Each emitter module stores the calibration values, which are then used in the subsequent operation of the emitter modules.

The synchronization module with the vehicle (controlled by the microcontroller/microprocessor) synchronizes the information display system in real-time with the emitter modules mounted on the tunnel walls. The synchronization occurs with each individual train car, using special markers.

The synchronization of the emitter modules is carried out with each train car to ensure stable image transmission. The only part directly connected to the metro train is the marker, which will be used to identify the beginning of each car, as well as each individual car. This synchronization is more precise because it involves not only measuring speed but also acceleration.

The video stream speed can vary depending on the speed of the passing car within a wide range.

Several synchronization methods for displaying images with a passing object are possible. In some cases, synchronization is not mandatory at all. In the case of a metro tunnel, synchronization is not required but is desirable.

The synchronization is adaptive, with each individual train car being synchronized, rather than the entire train. The train typically moves with acceleration (a common situation in metro or railway systems), and synchronization with the train as a whole is not sufficient to ensure high-quality image display. Sharp decelerations can also occur, which require more responsive synchronization.

Since each car is identified individually, the system contains real-time location information for each car. This information can be provided to external systems, such as a metro monitoring system, emergency systems, or others.

Several options for implementing synchronization with a passing object are possible.

In this example, optical synchronization is used.

Various methods can be used for synchronization, including different light-based solutions with speed measurement, ultrasound, high-frequency radiation in the radio wave range, and other methods.

There can be different options for synchronization, including static synchronization. For example, when using the system on a highway, all vehicles move at a certain speed that is at least above a certain threshold, and based on this paradigm, the image display system can work without specifically synchronizing with each passing vehicle, but rather by focusing on the average speed on the highway.

RGB LEDs will be used for display to ensure full-color video (other means of image formation are also possible).

The network module comprising the PON optical interface, responsible for data exchange with the central server, is controlled by the microcontroller/microprocessor.

High-precision clocks for module synchronization, ensuring parallel synchronization of all emitter modules for stable system operation over the optical PON (Passive Optical Network), are managed by the microcontroller/microprocessor.

To ensure the quality and depth of the image (dynamic range), the video information is stored and processed with a resolution of 8 bits or higher. The system is capable of displaying high-quality video in Full HD and 4K formats.

The video information display system for a moving object provides interactive communication with the viewer/passenger in the vehicle through a mobile application on the viewer's/passenger's phone, which connects to the server controlling the information display system in the tunnel.

For example, Wi-Fi or any other available connection that can provide data transmission via the internet network is used for the connection.

1. The viewer/passenger installs the app by scanning the QR code printed on the poster in the subway car and/or at the station (or displayed at the beginning of the video).

2. The advertisement invites the viewer to participate in the game—for example, fish chase squid, earning bonuses (such as discounts on services/products, etc.) from the advertiser. Other themes are possible (space, the ancient world, etc.).

3. Through the mobile app on the phone, the player can control the fish. Fish available for control have special tags (QR codes) that are unique within the given train route. The system can then determine which car the player is in and which window they are sitting by, linking the player to their fish. The fish may have a unique skin, which can be purchased (either by paying or winning in the game, using modern gaming mechanics). The choice of fish for the viewer/passenger to participate in the game can include various monetization models, from subscription models to purely bonus or random options. Other passengers in front of similar windows will see the fish's movement and can follow the game. To engage other passengers, including those from different cars, a betting system can be added.

4. The app controls the fish by reading data from the phone's gyroscope and accelerometer in blind mode (relative to the phone). This is to ensure that one hand of the passenger is free to hold the handrail.

5. During the game, the “controlled fish” will not leave the boundaries of the window to ensure comfortable gameplay, but NPCs (non-playable characters) will move along the entire length of the car to maintain the concept of immersion in another reality outside the train window.

6. To enhance engagement, the game may feature not only bonuses but also losing mechanics where the controlled fish could be eaten by a shark or another player (with more advanced, expensive equipment, and a corresponding skin that will be visible to others).

This significantly enhances the effect of the advertisement and increases the involvement of the viewer/passenger in the action unfolding outside their vehicle.

As an example, one of the specific implementations of the invention is provided in the form of the system installation in a metro tunnel.

In the metro tunnel, linear emitter modules 4 with LEDs (not shown) are mounted on both walls of the tunnel. The linear emitter modules are spaced evenly, for example, with a 1-meter interval. The height and placement of the linear emitter modules 4 ensure a high-quality view from the windows 2 of the metro train, providing the illusion of full immersion in another reality around the moving vehicle, such as 1.5 meters or more. The number of light-emitting elements in each linear emitter module 4 depends on the bandwidth and quality of the video to be displayed. High-quality video, such as Full HD or 4K, can be displayed. LEDs are currently capable of providing the required image transmission quality.

For example, if depicting the Barcelona aquarium with fish, one would expect the fish to “hang” in the window and move leisurely, rather than zipping past the viewer/passenger at a speed of 80 km/h.

Thus, the image is created in such a way that it appears relatively static to the viewer/passenger. However, the linear emitter modules, moving past the viewer/passenger, are traveling at a speed of approximately 28 modules per second, assuming they are spaced 1 meter apart, with the vehicle moving at roughly 80 km/h. The train may move at different speeds on different lines, and, for example, the electric train could be moving at a lower speed, such as 60 km/h. Nonetheless, choosing an interval of 1 meter between the emitter modules is quite reasonable. However, the system is not limited to this interval, and any other interval that ensures the required performance characteristics can be used.

The design of the proposed invention does not contain any mechanical moving parts, making it highly reliable and resistant to external influences (such as moisture, etc.), thus ensuring its protection against environmental factors.

The proposed modules do not contain moving parts and do not require regular maintenance.

To reduce production costs, the system has been developed such that the linear emitter module includes both a control unit and a display unit, and it can also connect to modules that only have display units. Additionally, a module may contain only a control unit, which can be connected to modules containing only display units. This configuration further reduces the overall cost of the system.

The wagon-based synchronization is contactless and does not require physical contact with the train, ensuring higher synchronization accuracy. It is also possible to transmit real-time location information of each metro train car to external systems.

The system allows for rapid and remote updates of displayed information, with information changes occurring very quickly.

The light-emitting elements can include LEDs, semiconductor lasers, or other light-generating devices.

Automatic Calibration (Claim 6): Automatic calibration ensures stable operation of the emitter modules. This calibration guarantees that all emitter modules have uniform brightness within the module and throughout the entire tunnel. During calibration, the current emitted by each LED driver chip is measured, and the pulse duration (or control current) applied to each LED is adjusted accordingly.

Interactive communication with the viewer/passenger in the vehicle is facilitated via a mobile application on the viewer's/passenger's phone, which connects to a server controlling the information display system in the tunnel.

Emergency Mode: The invention includes an emergency mode to assist in finding exits from the tunnel. The high reliability of the module connections ensures that the system can provide necessary support to passengers.

Service Information Display: The invention also includes a mode for displaying operational information to train operators. The system can quickly display critical information for train management, enhancing metro safety. This functionality is particularly valuable in large and complex metro systems, such as the New York City subway.

1. A video information display system for a moving vehicle in metro tunnels or transportation systems, comprising:
image-forming devices installed along a route of the moving vehicle at a height of windows of the moving vehicle, so that a viewer/passenger perceives information as a moving image;
wherein the video information display system further comprises a plurality of linear emitter modules oriented perpendicular to a direction of movement of the viewer/passenger;
wherein the linear emitter modules generate an image from a memory, synchronizing a display speed and method with a movement speed of the viewer/passenger relative to the linear emitter modules;
wherein the plurality of linear emitter modules are mounted outside the windows of the moving vehicle at equal distances from each other;
wherein each of the plurality of linear emitter modules has a height and a placement selected so as to ensure a high-quality view from the windows of the moving vehicle, thereby creating an illusion of full immersion in another reality within a space surrounding the moving vehicle;
wherein the plurality of linear emitter modules are interconnected via a network optical interface of a Passive Optical Network (PON);
wherein a number of light-emitting elements in each of the plurality of linear emitter modules depends on a bandwidth and quality of a displayed video;
wherein each of the plurality of linear emitter modules comprises a housing containing a display unit, and at least one of the plurality of linear emitter modules further comprises a control unit contained in the housing;
wherein the control unit includes:
a microcontroller/microprocessor configured to manage a process of extracting video frames from the memory and transmitting the video frames to the display unit of each of the plurality of linear emitter modules;
a network module comprising the network optical interface of the PON;
a synchronization module configured to perform synchronization with the moving vehicle;
high-precision clocks configured to provide synchronization of the plurality of linear emitter modules for stable operation of the video information display system over the PON and connected to the microcontroller/microprocessor;
wherein the display unit includes:
RGB LEDs configured to provide the displayed video as a full-color video;
LED drivers;
a driver control logic;
a stream receiver;
a power converter;
wherein the video information display management system provides interactive communication with the viewer/passenger in the moving vehicle.

2. The system according to claim 1, wherein the moving vehicle is a train comprising multiple train cars, each of the multiple train cars being individually synchronized with the plurality of linear emitter modules, and wherein the synchronization for each of the multiple train cars with the train is achieved using at least one of optical, laser, infrared beams, and ultrasound.

3. The system according to claim 1, wherein the display units are configured to display a high-quality video in Full HD and 4K formats.

4. The system according to claim 1, wherein, to ensure a sufficient display quality and video depth, video information is stored and processed by the control unit with a resolution of at least 8 bits.

5. The system according to claim 2, wherein the synchronization module transmits real-time location information of each of the multiple train cars to external systems.

6. The system according to claim 1, wherein the microcontroller is further configured to perform automatic calibration of the light-emitting elements.

7. The system according to claim 1, wherein the system provides interactive communication with the viewer/passenger in the moving vehicle through a mobile application on a phone of the viewer/passenger, the mobile application being configured to connect to a server controlling the system, and wherein the viewer/passenger, by using the mobile application, can control an object that will act outside the windows of the moving vehicle.

8. The system according to claim 1, in which the at least one linear emitter module comprising the control unit and the display unit controls the linear emitter modules comprising only the display units.

9. The system according to claim 1, in which the at least one linear emitter module comprising only the control unit controls the linear emitter modules comprising only the display units.
